(19) United States
(12) Patent Application Publication
(10) Pub. No.: US 2010/0086902 A1
(43) Pub. Date: Apr. 8, 2010

(54) WALL-MOUNTING DEVICE

(75) Inventor: Marion LANKTREE, Ottawa (CA)

Correspondence Address: SIMPSON & SIMPSON, PLLC, 5555 MAIN STREET, WILLIAMSVILLE, NY, 14221-5406, US

(73) Assignee: Umbra LLC, Buffalo, NY (US)

(21) Appl. No.: 12/569,102

(22) Filed: Sep. 29, 2009

Related U.S. Application Data
(63) Continuation-in-part of application No. 12/286,986, filed on Oct. 4, 2008.
Application No. 12/286,986 is a continuation-in-part of application No. 12/541,431, filed on Aug. 14, 2009.

(51) Int. Cl. G09B 25/00

(52) U.S. Cl. 434/72

(57) ABSTRACT

A wall-mountable device including a body, a plurality of members extending from the body and defining a substantially cylindrical recess having a substantially annular ridge, and a tack having a post extending from a disc-shaped head, wherein the post is adapted to be inserted into a wall, the disc-shaped head is adapted to be inserted into the substantially cylindrical recess and entrapped by the substantially annular ridge, and the body is removably secured to the tack when the disc-shaped head is entrapped by the substantially annular ridge.

### CROSS-REFERENCE TO RELATED APPLICATIONS

This is a continuation-in-part of U.S. patent application Ser. Nos. 12/286,986 filed on Oct. 4, 2008 and 12/541,431 filed on Aug. 14, 2009, which applications are incorporated herein by reference in their entireties.

### FIELD OF THE INVENTION

The invention broadly relates to devices for mounting objects to walls, and particularly to wall-mountable decorations.

### BACKGROUND OF THE INVENTION

Devices for mounting objects to walls are well known. Generally, such devices are used for hanging picture frames and objects, such as decorative masks and the like. A common problem with prior wall-mounting devices is the difficulty of maintaining alignment of the frames or decorations, as they may shift or even fall off their mounting means due to the application of even slight forces to the decoration itself, or even the wall or surface on which the decoration is mounted. Furthermore, many known mounting means are obtrusive, hard to conceal, or visibly unappealing.

Another solution, such as described in the co-pending parent application identified above, is to secure the decorations onto a surface via a magnet in the body of the decoration which attracts to a metallic nail or tack secured in the surface on which the decoration is to be mounted. This solution provides a means for securing a decoration to a wall, wherein the decoration is easily re-oriented, re-aligned, and re-positioned. However, in that embodiment only magnetic forces are securing the decoration to the nail or tack, and there are no mechanical means of securing the tack and the decoration together, so it is possible that the decoration may become separated from the tack if too much force is applied to the decoration, for example, if a user accidently hits or bumps into the decoration. Therefore, what is needed is a means for securing a decoration or the like to a wall or other surface, that can be easily re-oriented, re-aligned, or re-positioned, but that will more securely and mechanically hold the decoration or other object against the surface.

### BRIEF SUMMARY OF THE INVENTION

Generally, the present invention is a wall-mountable device comprising a body, a plurality of members extending from the body and defining a substantially cylindrical recess having a substantially annular ridge, and a tack having a post extending from a disc-shaped head, wherein the post is adapted to be inserted into a wall, the disc-shaped head is adapted to be inserted into the substantially cylindrical recess and entrapped by the substantially annular ridge, and the body is removably secured to the tack when the disc-shaped head is entrapped by the substantially annular ridge. In one embodiment, the device further comprises a disc arranged within the substantially cylindrical recess and fixed to the body. In one embodiment the body is adapted to rotate on the disc-shaped head when the disc-shaped head is entrapped by the substantially annular ridge and the post is inserted into the wall.

In one embodiment, the invention is a wall-mountable object comprising: a body; a plurality of members extending from the body and defining a substantially cylindrical recess having a substantially annular ridge, wherein the substantially cylindrical recess is adapted to receive and entrap a disc-shaped head of a tack behind the substantially annular ridge such that the body is removably secured to the tack when the disc-shaped head is entrapped behind the substantially annular ridge.

In one embodiment, the invention is a surface-mountable device comprising a body, at least one member extending from the body and defining a snap recess having a peripheral ridge, and a tack having a post extending from a head, wherein the post is adapted to be inserted into a surface, the head is adapted to be inserted into the snap recess and entrapped by the peripheral ridge, and the body is removably secured to the tack when the head is entrapped by the peripheral ridge. In one embodiment, the tack includes a spacer arranged on the post adjacent to the head, the spacer being adapted to provide distance between the head and the surface when the post is inserted into the surface. In one embodiment, the body further comprises a mounting face arranged within the snap recess, wherein the slab is operatively arranged to matingly engage the head of the tack when the head is entrapped by the peripheral edge.

It is an object of the present invention to provide a device for easily mounting objects, such as decorations, to a wall.

It is a further object of the invention to provide an object which is adapted to be mounted to a wall with a standard tack, and to conceal the tack behind the object when mounted.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a top, perspective view of a preferred embodiment of the present invention modular magnet assembly arranged as a plurality of nested modules;

FIG. 2 is a top, plan view of the modular magnet assembly showing the members and gaps of every module in axial alignment;

FIG. 3 is a top, plan view of the modular magnet assembly showing the members and gaps of every other module rotated into axial alignment;

FIG. 4 is an exploded perspective view of the modular magnet assembly;

FIG. 5 is a bottom perspective view the modular magnet assembly;

FIG. 6 is a side, elevational view of the modular magnet assembly;

FIG. 7 is a top, plan view of the plurality of modules separated and affixed to a vertical surface;

FIG. 8 is a side, elevational view of the plurality of modules separated;

FIG. 9 is a bottom, plan view of the plurality of modules separated;

FIG. 10 is a cross-sectional view taken generally along line 10-10 in FIG. 7;

FIG. 11 is a perspective view of a second embodiment of the current invention illustrating a body detached from a tack secured in a surface;

FIG. 12 is a side, elevational view of a body secured to a surface, where the surface is shown in cross-section;

FIG. 13 is a top, plan view of the current invention mounting device;

FIG. 14a is a cross-sectional view of the mounting device secured to a surface generally taken along line 14-14 in FIG. 13;

FIG. 14b is an enlarged view of the area of the mounting device generally encircled in FIG. 14a; and,

FIG. 15 is a bottom view of a body of the current invention mounting device showing a snap recess of the body.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims. Unless defined otherwise, all technical and scientific terms used herein have the same meaning as commonly understood to one of ordinary skill in the art to which this invention belongs.

It should be appreciated that the terms “central axis” or “axis of rotation”, when used herein, refer to a line about which a three-dimensional body, e.g., the present invention modular ornamental magnet assembly, is substantially symmetrical, and such terms may be used interchangeably as appearing in the specification and claims. Moreover, the terms “axial” or “coaxial” are directional terms and refer to that which is situated on, along, or in the direction of the central axis or axis of rotation, and such terms may be used interchangeably as appearing in the specification and claims. The term “radial” refers to an arrangement parts extending from the central axis, preferably uniformly, like rays or radii.

It should also be appreciated that the term “whorl”, when used herein, refers to a circular arrangement of like parts, such as leaves, petals, or wings, around a point on an axis. In other words, the term refers a plurality of like parts, such as leaves, petals, or wings, extending radially from a central axis or axis of rotation.

It should also be appreciated that the verb “to nest”, when used herein, refers to fitting or placing one object within another object. The term “nested” refers to an object placed or fitted within another object, especially in a compact, stacked formation. Additionally, the term “nestable” refers to a structural arrangement wherein one object is arranged to be placed or fitted within another object.

Although many methods, devices or materials similar or equivalent to those described herein can be used in the practice or testing of the invention, the preferred methods, devices, and materials are now described.

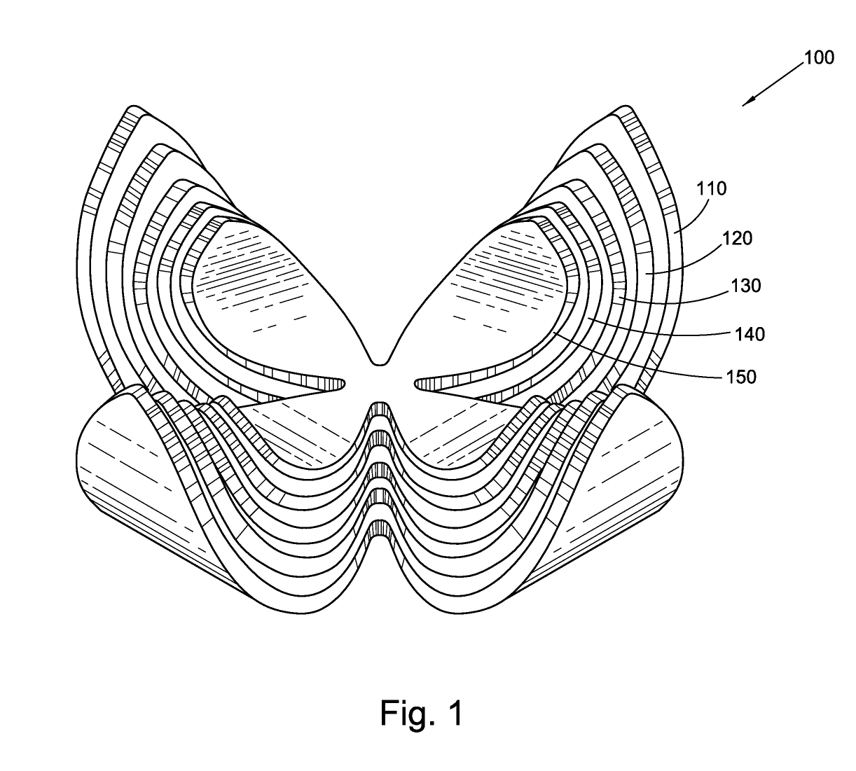

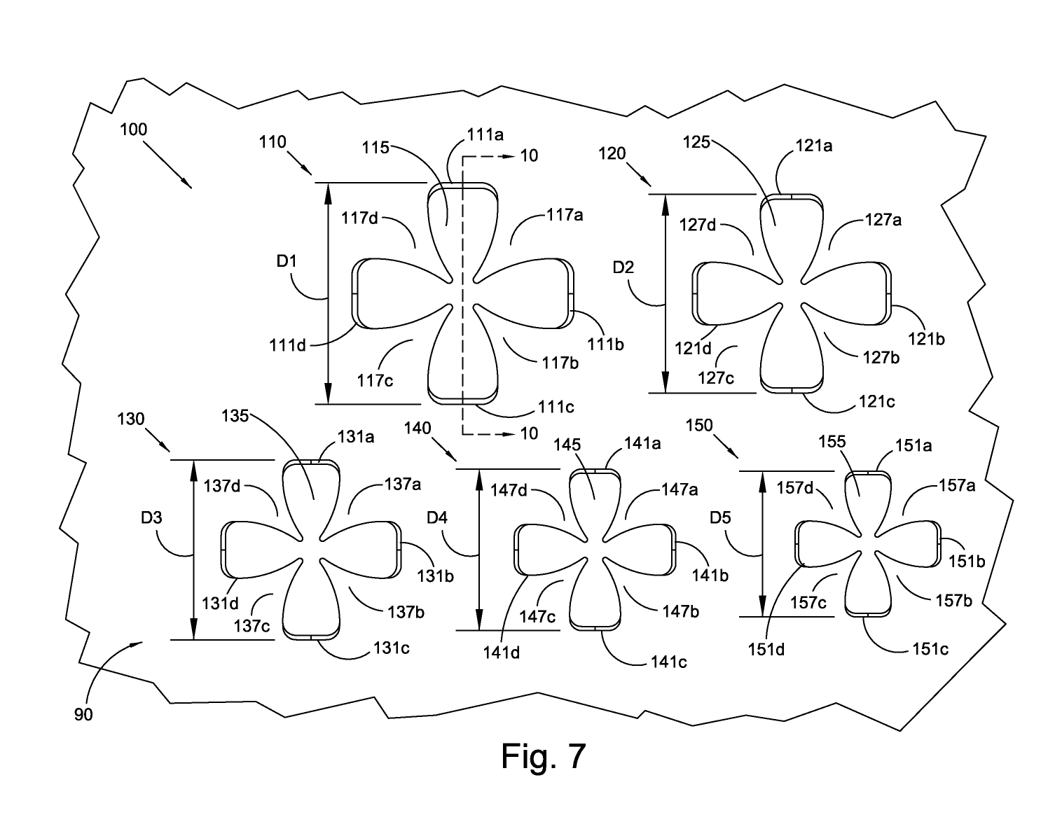

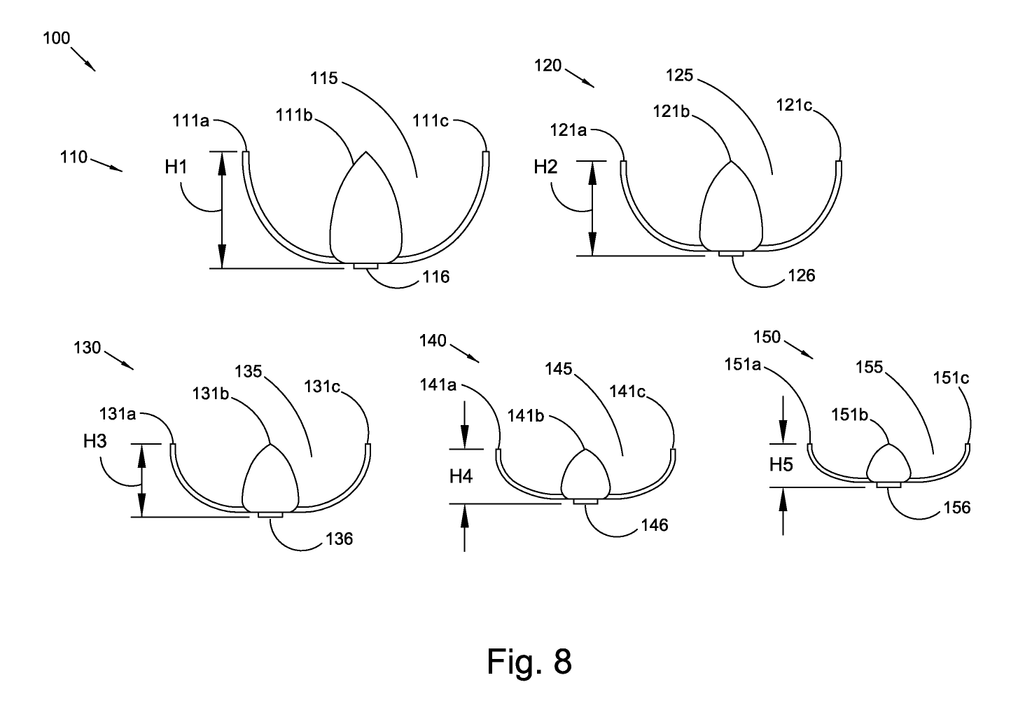

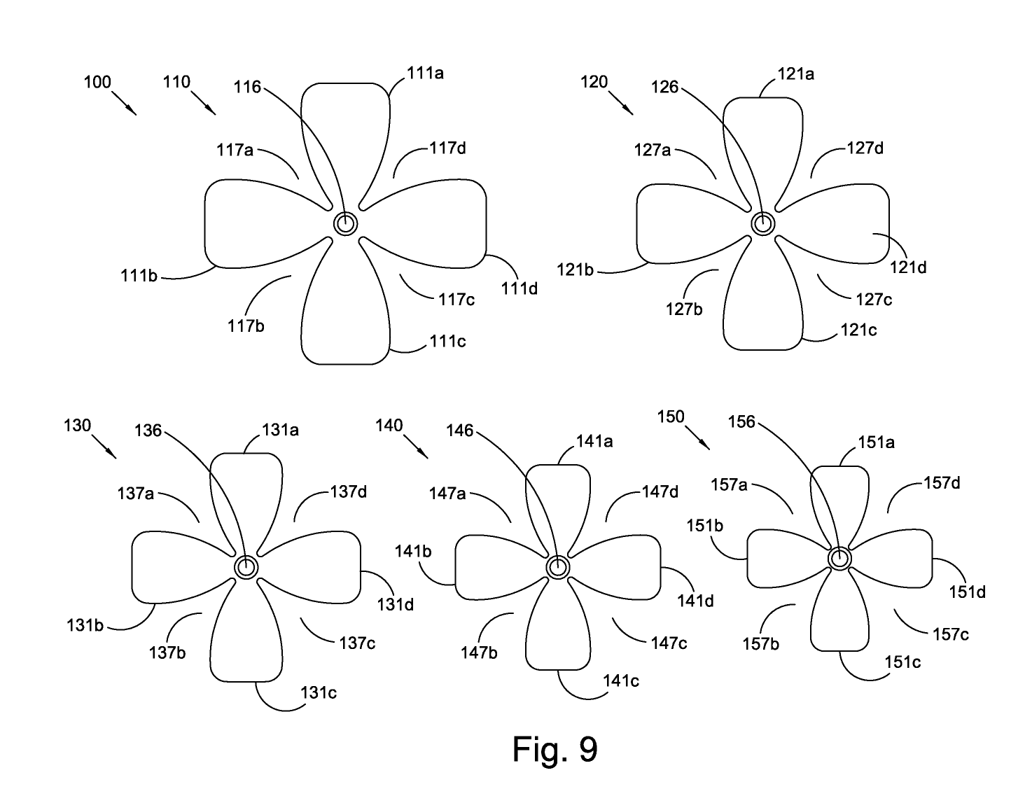

Adverting now to the figures, FIG. 1 is a top, perspective view of a preferred embodiment of the present invention modular magnet assembly, hereinafter referred to as magnet assembly 100. Magnet assembly 100 comprises a plurality of modules of different sizes, namely, first module 110, second module 120, third module 130, fourth module 140, and fifth module 150. In this embodiment, as described in further detail infra and shown in FIGS. 7-9, each module of magnet assembly 100 may be arranged as a whorl of generally uniform, petal-shaped members, and gaps defined therebetween, extending from a centrally arranged magnet.

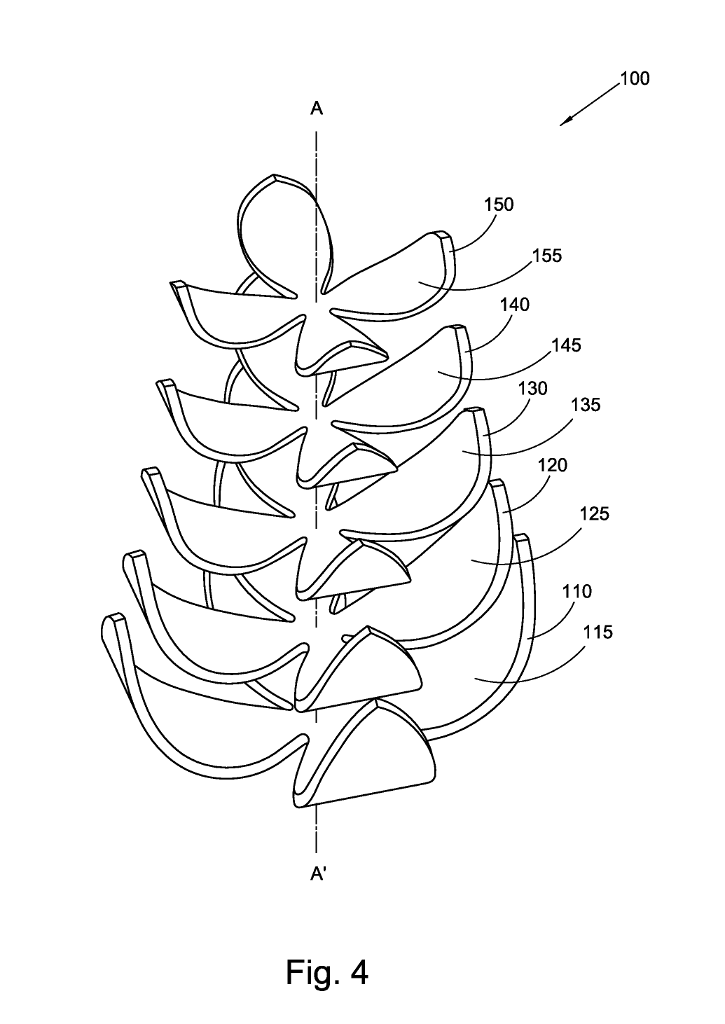

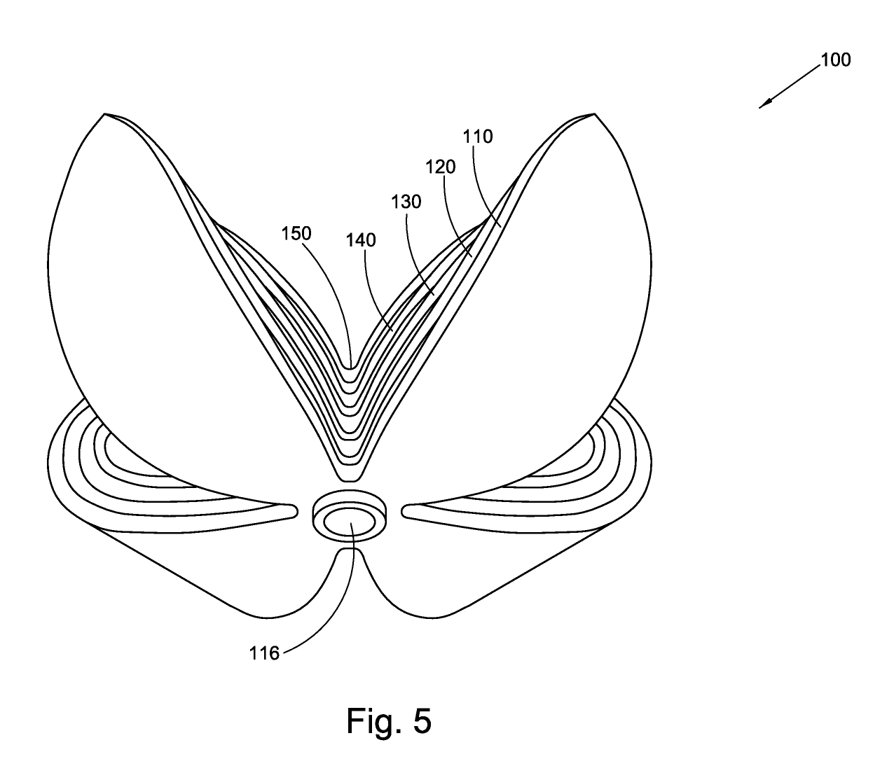

FIG. 4 shows the plurality of modules aligned along axis A-A′. As shown in this figure, the members of first module 110 curve in a coaxial direction and define a cavity 115; the members of second module 120 curve in a coaxial direction and define a cavity 125; the members of third module 130 curve in a coaxial direction and define a cavity 135; the members of fourth module 140 curve in a coaxial direction and define a cavity 145; and, the members of fifth module 150 curve in a coaxial direction and define a cavity 155. As shown in FIGS. 1-6, the plurality of modules may be stacked and nested in order of progressively decreasing size along axis A-A′. Each stacked module is nested within the cavity of the module upon which it is stacked. In particular, fifth module 150 is stacked upon fourth module 140 and nested within cavity 145; fourth module 140 is stacked upon third module 130 and nested within cavity 135; third module 130 is stacked upon second module 120 and nested within cavity 125; and, second module 120 is stacked upon first module 110 and nested within cavity 115. First module 110, being the largest module, is not nestable within any other module and serves as the base of magnet assembly 100.

When the modules are in a stacked and nested arrangement, the magnets of the modules are axially aligned and magnetically attracted to each other. Such magnetic attraction is preferably of sufficient strength to secure the plurality of modules in the stacked and nested arrangement.

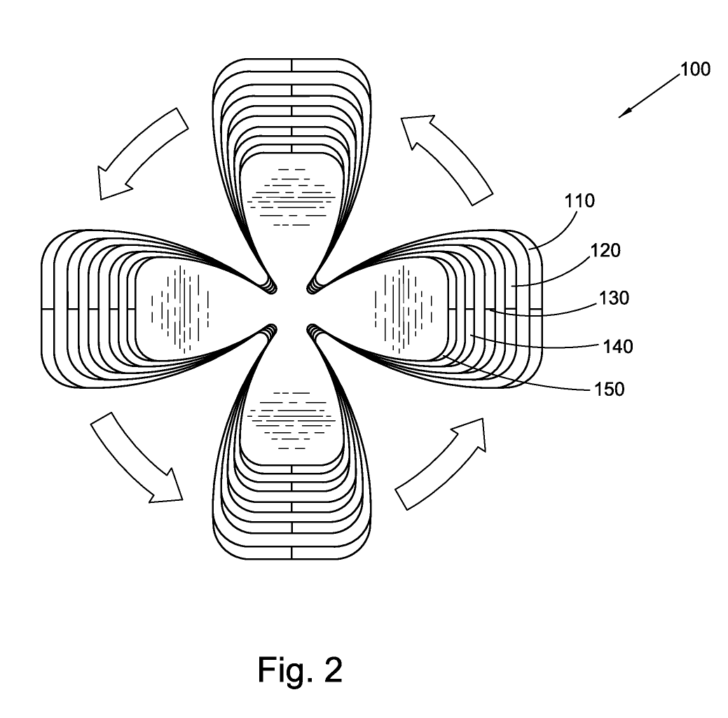

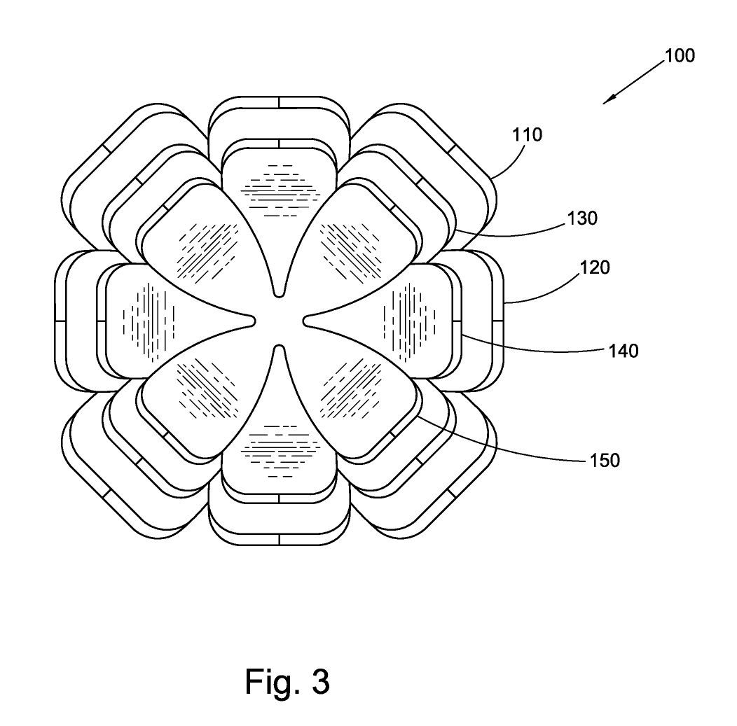

As shown in FIG. 2, the plurality of modules may be stacked and nested such that the respective members and gaps of every module are in axial alignment. As shown in FIG. 3 the plurality of modules may be stacked and nested such that the respective members and gaps of every other module are in axial alignment, i.e., the respective members and gaps of modules 110, 130, and 150 are in axial alignment, and the respective members and gaps of modules 120 and 140 are in axial alignment. Preferably, as indicated with the arrows in FIG. 2, whorls 110, 120, 130, 140, and 150 are rotatable when they are in a stacked and nested arrangement so that the members and gaps of each module may rotated in and out of alignment.

As shown in FIGS. 7-9, first module 110 comprises first plurality of members 111a-d, and first plurality of gaps 117a-d defined therebetween, extending radially from first magnet 116, which is arranged in the center of first module 110. As shown in the figures, each member of first plurality of members 111a-d includes a proximal end affixed to first magnet 116 and a distal end arranged opposite the proximal end. Additionally, first plurality of members 111a-d is preferably uniform, petal-shaped, curved in a coaxial direction as they extend from first magnet 116. Such curvature of first plurality of members 111a-d provides a generally concave top surface, which defines first cavity 115, and a convex bottom surface. In the embodiment shown in the figures, first magnet 116 is affixed to the proximal ends of first plurality of members 111a-d on the convex bottom surface.

First module 110 includes first diameter D1 and first height H1, which is defined by the longest axial distance between the distal end and the proximal end of any member of first plurality of members 111a-d. Since members 111a-d are substantially uniform, the distances between the distal end and the proximal end of each member each member 111a-d are substantially equal.

Second module 120 comprises second plurality of members 121a-d, and second plurality of gaps 127a-d defined therebetween, extending radially from second magnet 126, which is arranged in the center of second module 120. As shown in the figures, each member of second plurality of members 121a-d includes a proximal end affixed to second magnet 126 and a distal end arranged opposite the proximal end. Additionally, second plurality of members 121a-d are preferably uniform, petal-shaped, and curved in a coaxial direction as they extend from second magnet 126. Such curvature of second plurality of members 121a-d provides a generally concave top surface, which defines second cavity 125, and a convex bottom surface. In the embodiment shown in the figures, second magnet 126 is affixed to the proximal ends of second plurality of members 121a-d on the convex bottom surface.

Second module 120 includes second diameter D2 and second height H2, which is defined by the longest axial distance between the distal end and the proximal end of any member of second plurality of members 121a-d. Since members 121a-d are substantially uniform, the distances between the distal end and the proximal end of each member each member 121a-d are substantially equal.

Third module 130 comprises third plurality of members 131a-d, and third plurality of gaps 137a-d defined therebetween, extending radially from third magnet 136, which is arranged in the center of third module 130. As shown in the figures, each member of third plurality of members 131a-d includes a proximal end affixed to third magnet 136 and a distal end arranged opposite the proximal end. Additionally, third plurality of members 131a-d are preferably uniform, petal-shaped, and curved in a coaxial direction as they extend from third magnet 136. Such curvature of third plurality of members 131a-d provides a generally concave top surface, which defines third cavity 135, and a convex bottom surface. In the embodiment shown in the figures, third magnet 136 is affixed to the proximal ends of third plurality of members 131a-d on the convex bottom surface.

Third module 130 includes third diameter D3 and third height H3, which is defined by the longest axial distance between the distal end and the proximal end of any member of third plurality of members 131a-d. Since members 131a-d are substantially uniform, the distances between the distal end and the proximal end of each member each member 131a-d are substantially equal.

Fourth module 140 comprises fourth plurality of members 141a-d, and fourth plurality of gaps 147a-d defined therebetween, extending radially from fourth magnet 146, which is arranged in the center of fourth module 140. As shown in the figures, each member of fourth plurality of members 141a-d includes a proximal end affixed to fourth magnet 146 and a distal end arranged opposite the proximal end. Additionally, fourth plurality of members 141a-d are preferably uniform, petal-shaped, and curved in a coaxial direction as they extend from fourth magnet 146. Such curvature of fourth plurality of members 141a-d provides a generally concave top surface, which defines fourth cavity 145, and a convex bottom surface. In the embodiment shown in the figures, fourth magnet 146 is affixed to the proximal ends of fourth plurality of members 141a-d on the convex bottom surface.

Fourth module 140 includes fourth diameter D4 and fourth height H4, which is defined by the longest axial distance between the distal end and the proximal end of any member of fourth plurality of members 141a-d. Since members 141a-d are substantially uniform, the distances between the distal end and the proximal end of each member each member 141a-d are substantially equal.

Fifth module 150 comprises fifth plurality of members 151a-d, and fifth plurality of gaps 157a-d defined therebetween, extending radially from fifth magnet 156, which is arranged in the center of fifth module 150. As shown in the figures, each member of fifth plurality of members 151a-d includes a proximal end affixed to fifth magnet 156 and a distal end arranged opposite the proximal end. Additionally, fifth plurality of members 151a-d are preferably uniform, petal-shaped, and curved in a coaxial direction as they extend from fifth magnet 156. Such curvature of fifth plurality of members 151a-d provides a generally concave top surface, which defines fifth cavity 155, and a convex bottom surface. In the embodiment shown in the figures, fifth magnet 156 is affixed to the proximal ends of fifth plurality of members 151a-d on the convex bottom surface.

Fifth module 150 includes fifth diameter D5 and fifth height H5, which is defined by the longest axial distance between the distal end and the proximal end of any member of fifth plurality of members 151a-d. Since members 151a-d are substantially uniform, the distances between the distal end and the proximal end of each member each member 151a-d are substantially equal.

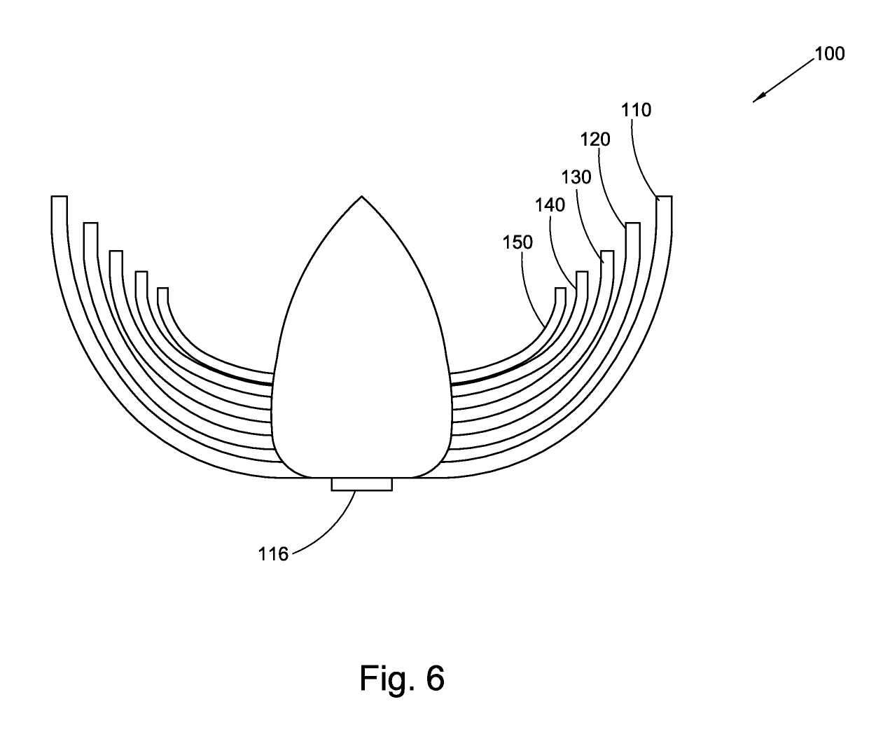

It should be appreciated that the plurality of modules are stackable and nestable in order of decreasing size, i.e., from largest to smallest, primarily because: D1 is greater than D2, D2 is greater than D3, D3 is greater than D4, and D4 is greater than D5; and, H1 is greater than H2, H2, is greater than H3, H3 is greater than H4, and H4 is greater than H5, as illustrated in FIG. 6.

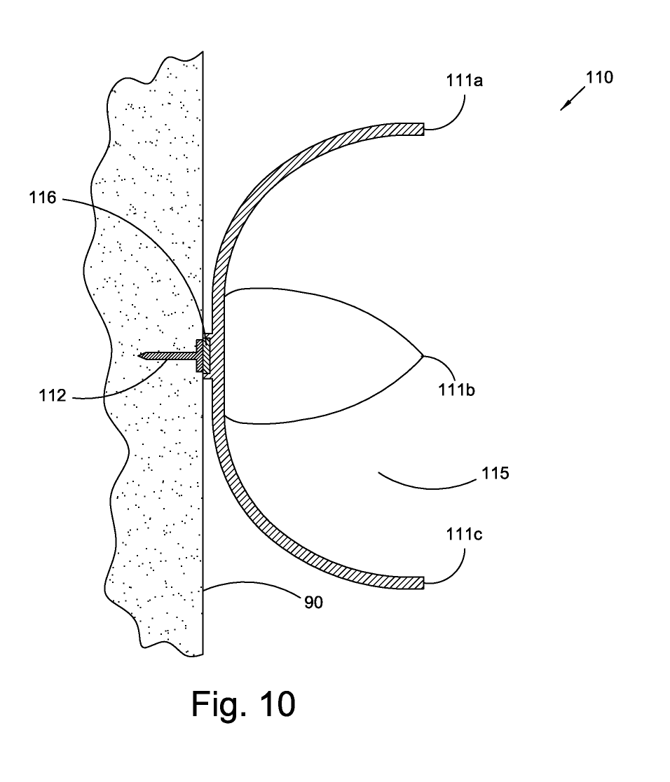

As magnet assembly 100 comprises a plurality of separate modules, each of which includes a magnet from which its members extend, each module may be secured to a surface by means of magnetic attraction between the magnet and the surface. For example, as shown in FIG. 7, first module 110, second module 120, third module 130, fourth module 140, and fifth module 150 are each secured to vertical surface 90 by means of a magnetic attraction between first magnet 116, second magnet 126, third magnet 136, fourth magnet 146, and fifth magnet 156, respectively, and a nail embedded in vertical surface 90, which nail comprises a magnetically attractable material, such as iron. For example, as shown in FIG. 10, first module 100 is secured to vertical surface 90 by means of a magnetic attraction between first magnet 116 and nail 112.

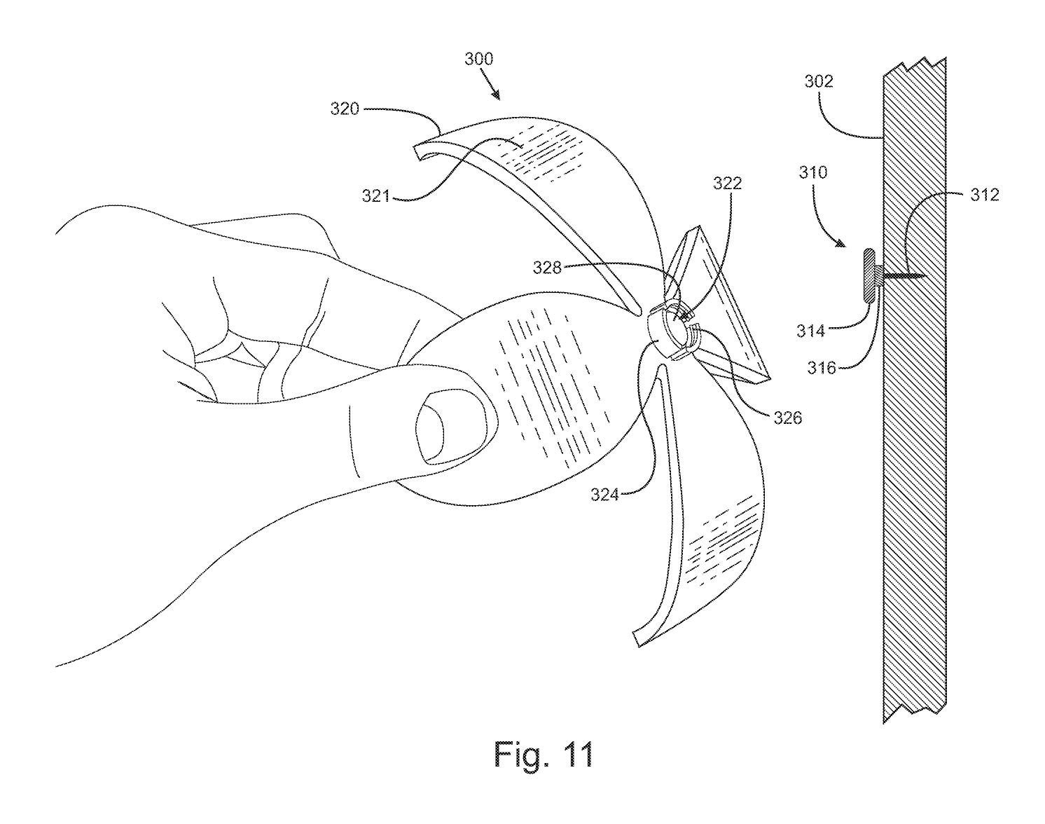

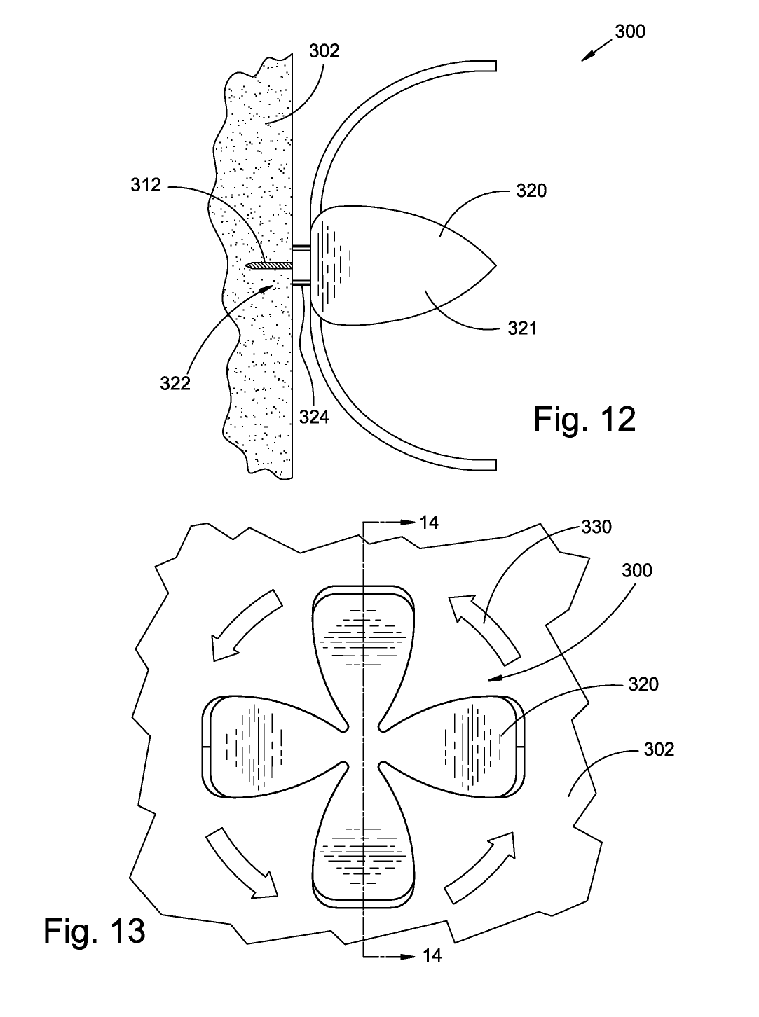

FIGS. 11-15 illustrate one embodiment of the present invention. Mounting device 300 includes tack 310 and body 320. Tack 310 is secured in surface 302 by means of post 312, which is inserted into surface 302. Surface 302 could be, for example, a wall, ceiling, floor, bulletin board, or anywhere else one would want to secure the mounting device or a plurality of mounting devices. Body 320 is shown resembling a cupped flower having curved petals 321 for aesthetic purposes, but it should be understood that body 320 could take the form of other shapes, such as stars, animals, insects, people, or any other desired shape. Body 320 of mounting device 300 includes snap recess 322 which is formed by at least one wall member 324 extending from the body. Wall members 324 include a substantially ridge 326, about the inner periphery of recess 322.

Post 312 extends from head 314 of tack 310. Body 320 is detachably securable to surface 302 via tack 310 by inserting head 314 of the tack into recess 322 such that head 314 is entrapped by peripheral ridge 326. That is, the peripheral ridge is preferably formed such that it forms an opening which is slightly smaller than the size of head 314, thereby requiring a user to apply sufficient force to snap or press the head past the ridge. The tack may include spacer 316 to space the head away from surface 302 such that wall members 324 do not protrude against or into surface 302 when body 320 is pressed onto tack 310. The head, the spacer, and/or the post of tack 310 may be integrated into a single piece, or may be separate pieces affixed together. In the shown embodiment tack 310 resembles a pushpin having a disc-shaped head and a ring-shaped spacer which is arranged on the post. In this shown embodiment, recess 322 is substantially cylindrical and includes a substantially annual ridge 326. A plurality of wall members 324 may be included having a gap between each pair of adjacent wall members, such as to reduce the force necessary to snap the tack and the body together.

As indicated in FIG. 13 by arrows 330, once secured onto tack 310, body 320 is rotatable about the tack. Thus, the orientation of the body relative to the surface can be readily changed by a user as desired, and the body does not have to be removed from the tack or the surface to reorient the angle of the body. Although arrows 330 are in a generally counter-clockwise direction, it should be readily appreciated that body 320 is also rotatable in the clockwise direction.

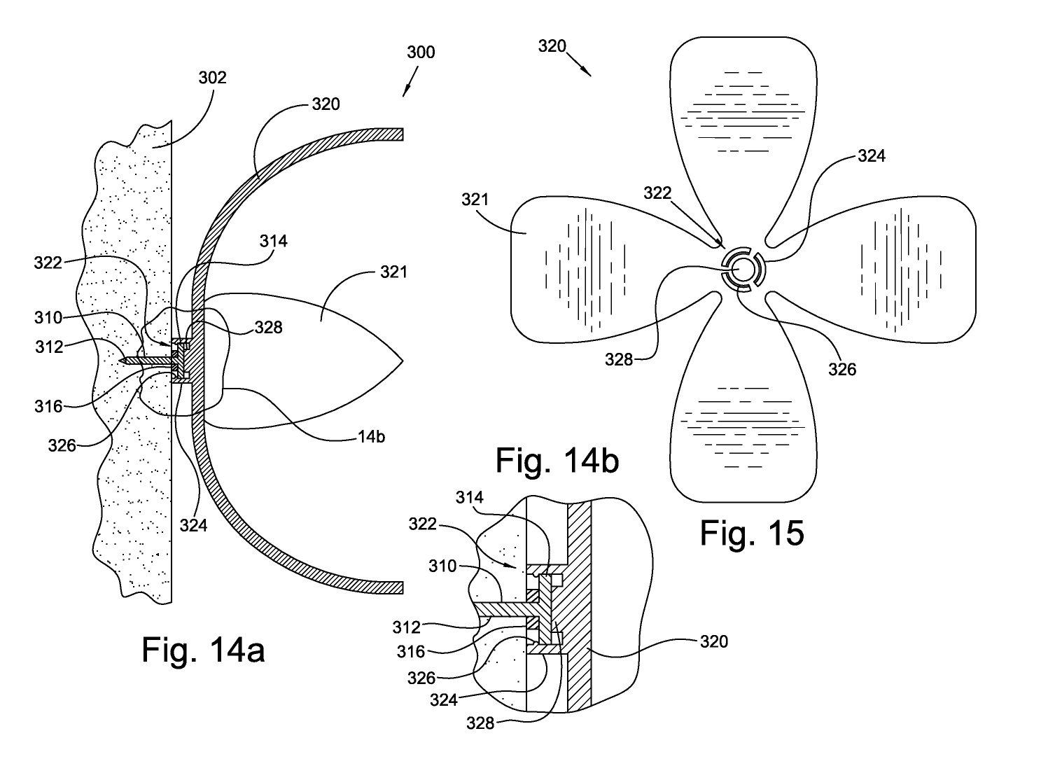

In one embodiment, the body may also include slab or disc 328 against which the head of the tack is engaged when entrapped by ridge 326. In one embodiment, the thickness of the head of the tack is approximately equal to an axial distance between slab 328 and ridge 326 such that head 314 is firmly held against body 320, as shown in FIGS. 14a and 14b.

It should be noted that tack 310 does not first have to be inserted into a surface, but instead that body 320 can first be attached to tack 310, then post 312 of the tack inserted into a surface. Further, mounting device 300 can be repositioned about surface 302 or moved to another surface by removing both body 320 and 310 and re-inserting post 312 of the tack in a new location.

It should further be appreciated that tacks 310 could be a standard pushpin or thumbtack used, for example, to hold up a poster or some other document on a wall or bulletin board. Body 320 could be a decorative shape, so that it would conceal the potentially unsightly tacks 310 and increase the aesthetics of the wall or surface. Alternatively, a plurality of bodies 320 could be chosen and arranged on a wall in a pattern, or even randomly, to create an interesting and aesthetically pleasing effect. For example, bodies of various sizes, such as bodies resembling modules 110, 120, 130, 140, and 150, could be chosen and affixed to a wall in a desired decorative arrangement via tacks 310. Lastly, one could, for example, create a combination of the disclosed embodiments by first affixing a snap-style body 320 to a surface via a metallic tack 310, then depending on the thickness of the body and strength of the magnet used, stacking a nested arrangement as generally shown in FIG. 3 by using the magnets to attract to the head of the metallic tack, through the thickness of the body.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A wall-mountable device comprising:
a body;
a plurality of members extending from the body and defining a substantially cylindrical recess having a substantially annular ridge; and,
a tack having a post extending from a disc-shaped head, wherein the post is adapted to be inserted into a wall, the disc-shaped head is adapted to be inserted into the substantially cylindrical recess and entrapped by the substantially annular ridge, and the body is removably secured to the tack when the disc-shaped head is entrapped by the substantially annular ridge.

2. The wall-mountable device recited in claim 1 further wherein the tack includes a spacer arranged on the post adjacent to the disc-shaped head, the spacer being adapted to provide distance between the disc-shaped head and the wall when the post is inserted into the wall.

3. The wall-mountable device recited in claim 1 further comprising a disc arranged within the substantially cylindrical recess and fixed to the body.

4. The wall-mountable device recited in claim 1 wherein the body is adapted to rotate on the disc-shaped head when the disc-shaped head is entrapped by the substantially annular ridge and the post is inserted into the wall.

5. A wall-mountable object comprising:
a body;
a plurality of members extending from the body and defining a substantially cylindrical recess having a substantially annular ridge, wherein the substantially cylindrical recess is adapted to receive and entrap a disc-shaped head of a tack behind the substantially annular ridge such that the body is removably secured to the tack when the disc-shaped head is entrapped behind the substantially annular ridge.

6. The wall-mountable object recited in claim 5 further comprising a disc arranged within the substantially cylindrical recess and fixed to the body.

7. A surface-mountable device comprising:
a body;
at least one member extending from the body and defining a snap recess having a peripheral ridge; and,
a tack having a post extending from a head, wherein the post is adapted to be inserted into a surface, the head is adapted to be inserted into the snap recess and entrapped by the peripheral ridge, and the body is removably secured to the tack when the head is entrapped by the peripheral ridge.

8. The surface-mountable device recited in claim 7 further wherein the tack includes a spacer arranged on the post adjacent to the head, the spacer being adapted to provide distance between the head and the surface when the post is inserted into the surface.

9. The surface-mountable device recited in claim 7 wherein the body further comprises a slab arranged within the snap recess, wherein the slab is operatively arranged to matingly engage the head of the tack when the head is entrapped by the peripheral edge.
